(19) United States
(12) Patent Application Publication
(10) Pub. No.: US 2023/0319932 A1
(43) Pub. Date: Oct. 5, 2023

(54) METHODS AND APPARATUS FOR PROVIDING ASSISTANT INFORMATION FOR UPLINK SCHEDULING

(71) Applicant: LENOVO (BEIJING) LIMITED, Beijing (CN)

(72) Inventor: Haipeng LEI, Beijing (CN)

(21) Appl. No.: 18/040,936

(22) PCT Filed: Aug. 7, 2020
(86) PCT No.: PCT/CN2020/107685

§ 371 Date: Feb. 7, 2023

(51) Int. Cl. H04W 76/18; H04B 7/06

(52) U.S. Cl. CPC H04W 76/18; H04B 7/0626

(57) ABSTRACT

Embodiments of the present disclosure relate to methods and apparatuses for providing assistant information for uplink scheduling. According to an embodiment of the present disclosure, a method for wireless communications may include counting a number of failed channel access procedures, and transmitting an indicator associated with the number of failed channel access procedures.

### TECHNICAL FIELD

Embodiments of the present disclosure are related to wireless communication technologies, and more particularly, related to methods and apparatuses for providing assistant information for uplink scheduling.

### BACKGROUND

3rd Generation Partnership Project (3 GPP) 5G new radio (NR) access on unlicensed spectrum (NR-U) has been developed recently. In order to achieve fair coexistence with other wireless systems, a channel access procedure, also named “listen before talk” (LBT) procedure, is required before a transmission on an unlicensed spectrum. The channel access procedure is a procedure based on channel sensing that evaluates the availability of a channel for performing the transmission.

A base station (BS) may schedule resource(s) for an uplink transmission for a user equipment (UE) on an unlicensed spectrum and attempt to receive the uplink transmission on the scheduled resource(s). However, the BS may fail to receive the uplink transmission from the UE on the scheduled resource(s) because the channel access procedure performed by the UE failed, or the uplink transmission from the UE suffers from hidden node interference. Then the BS needs to re-schedule resource(s) for the uplink transmission. It is desirable to provide some assistant information to enable the BS to know about the transmission failure reason (e.g., failed channel access procedure or hidden node interference) and accordingly schedule the uplink transmission more efficiently and more reliably, especially when the uplink traffic requires low latency and high reliability.

### SUMMARY OF THE DISCLOSURE

Embodiments of the present disclosure at least provide a technical solution for providing assistant information for uplink scheduling, e.g., on an unlicensed spectrum.

According to an embodiment of the present disclosure, a method for wireless communications may include counting a number of failed channel access procedures, and transmitting an indicator associated with the number of failed channel access procedures.

According to another embodiment of the present disclosure, a method for wireless communications may include receiving, from a UE, an indicator associated with a number of failed channel access procedures, and scheduling an uplink transmission for the UE based at least in part on the indicator.

According to another embodiment of the present disclosure, a method for wireless communications may include receiving an instruction to perform channel sensing within a period, performing channel sensing in sensing slots within the period, counting a number of failed sensing slots within the period, and transmitting an indicator associated with the number of failed sensing slots.

According to another embodiment of the present disclosure, a method for wireless communications may include transmitting, to a UE, an instruction to perform channel sensing in sensing slots within a period, receiving, from the UE, an indicator associated with a number of failed sensing slots within the period, and scheduling an uplink transmission for the UE based at least in part on the indicator.

According to yet another embodiment of the present disclosure, an apparatus may include: at least one non-transitory computer-readable medium having stored thereon computer executable instructions; at least one receiving circuitry; at least one transmitting circuitry; and at least one processor coupled to the at least one non-transitory computer-readable medium, the at least one receiving circuitry and the at least one transmitting circuitry. The computer executable instructions may cause the at least processor to implement a method according to any embodiment of the present disclosure.

The details of one or more examples are set forth in the accompanying drawings and the description below. Other features, objects, and advantages will be apparent from the description and drawings, and from the claims.

### BRIEF DESCRIPTION OF THE DRAWINGS

In order to describe the manner in which advantages and features of the present disclosure can be obtained, a description of the present disclosure is rendered by reference to specific embodiments thereof which are illustrated in the appended drawings. These drawings depict only exemplary embodiments of the present disclosure and are not therefore intended to limit the scope of the present disclosure.

FIG. 1 illustrates a schematic diagram of a wireless communication system according to some embodiments of the present disclosure;

FIG. 2 illustrates an exemplary flow chart of a method for providing assistant information for uplink scheduling according to some embodiments of the present disclosure;

FIG. 3 illustrates an exemplary flow chart of another method for providing assistant information for uplink scheduling according to some embodiments of the present disclosure;

FIG. 4 illustrates an exemplary block diagram of an apparatus according to some embodiments of the present disclosure; and

FIG. 5 illustrates an exemplary block diagram of another apparatus according to some embodiments of the present disclosure.

### DETAILED DESCRIPTION

The detailed description of the appended drawings is intended as a description of the currently preferred embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

In the following description, numerous specific details are provided, such as examples of programming, software modules, network transactions, database structures, hardware modules, hardware circuits, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference will now be made in detail to some embodiments of the present disclosure, examples of which are illustrated in the accompanying drawings. To facilitate understanding, embodiments are provided under specific network architecture and new service scenarios, such as 3GPP 5G, 3GPP Long Term Evolution (LTE) and so on. Persons skilled in the art know very well that, with the development of network architecture and new service scenarios, the embodiments in the present disclosure are also applicable to similar technical problems; and moreover, the terminologies recited in the present disclosure may change, which should not affect the principle of the present disclosure.

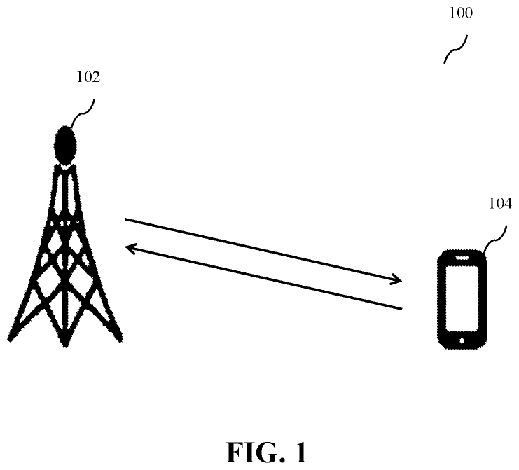

FIG. 1 illustrates a schematic diagram of a wireless communication system 100 according to some embodiments of the present disclosure.

As shown in FIG. 1, the wireless communication system 100 may include at least one BS 102 and at least one UE 104. Although a specific number of BSs 102 and UEs 104, e.g., only one BS 102 and one UE 104, are depicted in FIG. 1 for simplicity, one skilled in the art will recognize that any number of BSs 102 and UEs 104 may be included in the wireless communication system 100.

The wireless communication system 100 can be compatible with any type of network that is capable of sending and receiving wireless communication signals. For example, the wireless communication system 100 can be compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 102 may be distributed over a geographic region, and generally be a part of a radio access network that may include one or more controllers communicably coupled to one or more corresponding BSs 102. In some embodiments of the present disclosure, each BS 102 may also be referred to as an access point, an access terminal, a base, a macro cell, a node-B, an enhanced node B (eNB), a gNB, a home node-B, a relay node, or a device, or described using other terminology used in the art.

The UE 104 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, the UE 104 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 104 may include wearable devices, such as smart watches, fitness bands, optical head-mounted displays, or the like. Moreover, the UE 104 may be referred to as a subscriber unit, a mobile, a mobile station, a user, a terminal, a mobile terminal, a wireless terminal, a fixed terminal, a subscriber station, a user terminal, or a device, or described using other terminology used in the art.

The UE 104 may communicate with the BS 102 to receive data or signaling from the BS 102 on a downlink channel and transmit data or signaling to the BS 102 on an uplink channel.

When an unlicensed spectrum is applied, in order to achieve fair coexistence with other wireless systems, a channel access procedure (or LBT) is required before a transmission (no matter an uplink transmission or a downlink transmission) on the unlicensed spectrum. The channel access procedure is a procedure based on channel sensing that evaluates the availability of a channel for performing the transmission. The basic unit for channel sensing is a sensing slot with a duration Tₛₗ (e.g., 9 μs). The sensing slot is considered to be idle and can be called “a successful sensing slot” if a BS or a UE senses the channel (i.e., detecting an energy on the channel) during the sensing slot, and determines that the detected energy for at least, for example, 4 us within the sensing slot is less than an energy detection threshold X_{Thresh}. Otherwise, the sensing slot is considered to be busy and can be called “a failed sensing slot.”

In NR-U, when a BS (e.g., gNB) or a UE intends to initiate a channel occupancy time (COT) for a downlink or uplink transmission, a Type 1 downlink or uplink channel access procedure is performed on a channel. The Type 1 downlink or uplink channel access procedure is also named “LBT Category 4” or “LBT Cat.4” during standardization. As long as the Type 1 downlink or uplink channel access procedure is successful, the BS or UE can start the downlink or uplink transmission on the channel and occupy the channel up to a maximum channel occupancy time (MCOT); otherwise, the BS or UE cannot start the downlink or uplink transmission and continues to perform channel access procedure(s) until a successful channel access procedure. In some other cases, a simpler procedure, i.e., Type 2 channel access procedure (also named “LBT Category 2” or “LBT Cat.2”), is performed. The Type 2 channel access procedure can be further classified into Type 2A, Type 2B, and Type 2C channel access procedures. The Type 1, Type 2A, Type 2B, and Type 2C channel access procedures are specifically defined in the 3GPP standard document TS37.213.

For a physical uplink shared channel (PUSCH) transmission in a resource scheduled by an uplink grant for a UE, in the case of dynamic channel access mode, a detailed uplink channel access type (e.g., Type 1, Type 2A, Type 2B, or Type 2C channel access procedure) is indicated in the uplink grant, while in the case of semi-static channel access mode (i.e., frame based equipment (FBE) mode), there is no such uplink channel access type indication since the UE only senses a channel for at least a sensing slot duration Tₛₗ=9 μs within a 25 μs interval ending immediately before the transmission. In either case, only if the channel access procedure is successful, the UE can start the PUSCH transmission on the scheduled resource; otherwise, the UE has to drop the PUSCH transmission on the scheduled resource.

On the other hand, from the perspective of a B S, it configures or schedules for a UE a PUSCH transmission in a resource in advance and attempts to receive the PUSCH in the resource. When the BS does not receive the PUSCH, the reason may be that the UE fails to transmit the PUSCH due to an uplink channel access failure or the experienced channel between the UE and the BS suffers hidden node interference during the PUSCH transmission. If the real reason is that the channel access performed by the UE failed, then the BS just needs to send another uplink grant for scheduling retransmission; if the real reason is the hidden node interference, then the BS needs to indicate the UE to use a lower modulation and coding scheme (MCS) or higher uplink transmit power to combat the hidden node interference, or schedule the UE on another carrier among multiple carriers with a lower load or better channel condition. However, the BS cannot know the real reason without any assistant information from the UE.

Consequently, if the UE can transmit some assistant information to the BS about the uplink channel access or channel variation on the operating channel, the BS can know the practical reason and schedule the UE's uplink transmission more efficiently and more reliably especially when the uplink traffic requires low latency and high reliability.

Embodiments of the present disclosure provide methods for a UE to provide assistant information to a BS for uplink scheduling enhancement.

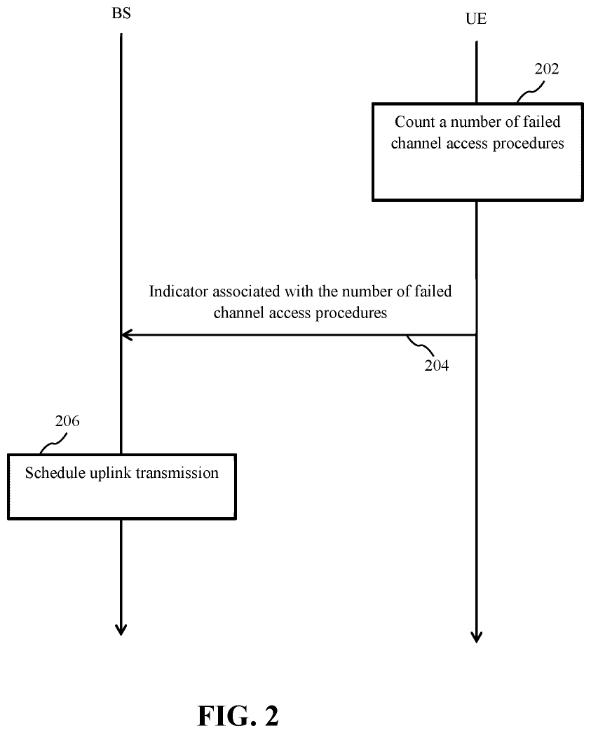

FIG. 2 illustrates an exemplary flow chart of a method for providing assistant information for uplink scheduling according to some embodiments of the present disclosure. The BS and the UE illustrated in FIG. 2 may be any BS (e.g., the BS 102 in FIG. 1) and any UE (e.g., the UE 104 in FIG. 1) described herein.

As described above, the UE may perform a channel access procedure before each uplink transmission over unlicensed spectrum, and determine whether to perform or drop the uplink transmission based on whether the channel access procedure is successful or failed. As shown in FIG. 2, the UE may count a number of failed channel access procedures at operation 202. This can be implemented by maintaining at least one counter at the UE side and updating the at least one counter each time after the UE performs a channel access procedure. The at least one counter can be referred to as “channel access failure counter.”

The channel access procedures performed by the UE for different types of uplink channels, e.g., PUSCH and physical uplink control channel (PUCCH), may have different probabilities of success. According to some embodiments of the present disclosure, the UE may maintain separate counters for different types of uplink channels respectively. For example, the UE may maintain a first counter to count a first number of failed channel access procedures for PUSCH and a second counter to count a second number of failed channel access procedures for PUCCH. The first counter is updated each time after the UE performs a channel access procedure for PUSCH. When the channel access procedure for PUSCH is successful, the first counter is reset to zero; when the channel access procedure for PUSCH fails, the first counter is incremented by one. Similarly, the second counter is updated each time after the UE performs a channel access procedure for PUCCH. When the channel access procedure for PUCCH is successful, the second counter is reset to zero; when the channel access procedure for PUCCH fails, the second counter is incremented by one. According to some other embodiments of the present disclosure, the UE may maintain a single counter to count failed channel access procedures for different types of uplink channels. The single counter is updated each time after the UE performs a channel access procedure regardless of the uplink channel type. When the channel access procedure for any type of uplink channel is successful, the counter is reset to zero; when the channel access procedure for any type of uplink channel fails, the counter is incremented by one.

Different channel access procedures, e.g., Type 1 channel access procedure and Type 2 channel access procedure, performed by the UE, may have different probabilities of success. According to some embodiments of the present disclosure, the UE may maintain separate counters for different types of channel access procedures respectively. For example, the UE may maintain a first counter to count a first number of failed Type 1 channel access procedures and a second counter to count a second number of failed Type 2 channel access procedures. The first counter is updated each time after the UE performs a Type 1 channel access procedure. When the Type 1 channel access procedure is successful, the first counter is reset to zero; when the Type 1 channel access procedure fails, the first counter is incremented by one. Similarly, the second counter is updated each time after the UE performs a Type 2 channel access procedure. When the Type 2 channel access procedure is successful, the second counter is reset to zero; when the Type 2 channel access procedure fails, the second counter is incremented by one. According to some other embodiments of the present disclosure, the UE may maintain a single counter to count different types of failed channel access procedures. The single counter is updated each time after the UE performs a channel access procedure regardless of the channel access procedure type. When any type of channel access procedure is successful, the counter is reset to zero; when any type of channel access procedure fails, the counter is incremented by one.

When the UE has multiple uplink transmit beams, independent channel access procedures may be performed before transmission(s) on one or more uplink transmit beams and may have different probabilities of success. According to some embodiments of the present disclosure, the UE may maintain separate counters for different uplink transmit beams respectively. For example, the UE may maintain a first counter to count a first number of failed channel access procedures for a first uplink transmit beam, and maintain a second counter to count a second number of failed channel access procedures for a second uplink transmit beam. The first counter is updated each time after the UE performs a channel access procedure for the first uplink transmit beam. When the channel access procedure for the first uplink transmit beam is successful, the first counter is reset to zero; when the channel access procedure for the first uplink transmit beam fails, the first counter is incremented by one. Similarly, the second counter is updated each time after the UE performs a channel access procedure for the second uplink transmit beam. When the channel access procedure for the second uplink transmit beam is successful, the second counter is reset to zero; when the channel access procedure for the second uplink transmit beam fails, the second counter is incremented by one. According to some other embodiments of the present disclosure, the UE may maintain a single counter to count failed channel access procedures for different uplink transmit beams. The single counter is updated each time after the UE performs a channel access procedure regardless of the uplink transmit beam. When the channel access procedure for any uplink transmit beam is successful, the counter is reset to zero; when the channel access procedure for any uplink transmit beam fails, the counter is incremented by one.

The above counter setting and updating mechanisms can be combined in various manners. When the UE has a number of M uplink transmit beams, and two types of channel access procedures (e.g., Type 1 channel access procedure and Type 2 channel access procedure) are used for two types of uplink channels (e.g., PUSCH and PUCCH), at most M*2*2 counters may be maintained at the UE side.

For example, when the UE has two uplink transmit beams, and two types of channel access procedures (e.g., Type 1 channel access procedure and Type 2 channel access procedure) are used for two types of uplink channels (e.g., PUSCH and PUCCH), at most 8 counters may be maintained at the UE side.

In an embodiment, for a first uplink transmit beam, a first counter is maintained for PUSCH transmissions with Type 1 channel access procedures, a second counter is maintained for PUSCH transmissions with Type 2 channel access procedures, a third counter is maintained for PUCCH transmissions with Type 1 channel access procedures, and a fourth counter is maintained for PUCCH transmissions with Type 2 channel access procedures; for a second uplink transmit beam, a fifth counter is maintained for PUSCH transmissions with Type 1 channel access procedures, a sixth counter is maintained for PUSCH transmissions with Type 2 channel access procedures, a seventh counter is maintained for PUCCH transmissions with Type 1 channel access procedures, and an eighth counter is maintained for PUCCH transmissions with Type 2 channel access procedures.

In another embodiment, for a first uplink transmit beam, a first counter is maintained for PUSCH transmissions with any type of channel access procedures, and a second counter is maintained for PUCCH transmissions with any type of channel access procedures; for a second uplink transmit beam, a third counter is maintained for PUSCH transmissions with any type of channel access procedures, and a fourth counter is maintained for PUCCH transmissions with any type of channel access procedures. Other counter setting manners can be applied without departing from the spirit and scope of the disclosure.

According to some embodiments of the present disclosure, each channel access failure counter maintained at the UE side may have a respective maximum value. In an embodiment, the maximum value can be predefined in standards. In another embodiment, the maximum value can be configured by the BS. For example, the BS may select the maximum value from a set of possible values and indicate it to the UE via a signaling (e.g., radio resource control (RRC) signaling). According to some embodiments of the present disclosure, when the value of a channel access failure counter reaches its respective maximum value, it will not be incremented upon any failed channel access procedure until being reset.

As shown in FIG. 2, at operation 204, the UE may transmit an indicator associated with the number of failed channel access procedures counted at operation 202 to the BS. The indicator can be transmitted on an unlicensed carrier or a licensed carrier.

According to some embodiments of the present disclosure, in the case that a single channel access failure counter is maintained at the UE side, the indicator can be a bit for indicating whether the number of failed channel access procedures (represented by the value of the counter) reaches a maximum value (e.g., the predefined or configured maximum value of the counter). For example, when the value of the counter is larger than or equal to the maximum value, the bit is set to “1”; otherwise, the bit is set to “0”.

In an embodiment, the indicator may be contained in periodic channel state information (CSI) reporting as an independent field. The reporting period of the indicator may be M times of the configured CSI reporting period, wherein M is a positive integer and can be configured by an RRC signaling. The presence of the field containing the indicator can be configured by an RRC signaling.

In another embodiment, the indicator may be contained in aperiodic CSI reporting as an independent field. The aperiodic CSI reporting can be triggered by the BS when the BS does not receive dynamically scheduled PUSCH or PUCCH for a while. The presence of the field containing the indicator can be configured by an RRC signaling.

In yet another embodiment, the indicator may be contained in a hybrid automatic repeat request (HARQ) acknowledgment (ACK) codebook as an independent field. For example, the indicator can be placed in the end of the HARQ-ACK codebook when the periodical CSI reporting collides with the HARQ-ACK codebook in the same slot. The HARQ-ACK codebook may not contain the indicator when the periodic CSI reporting is transmitted in a different slot. So it might be unnecessary to reserve a field in the HARQ-ACK codebook for transmitting the indicator.

According to some other embodiments of the present disclosure, in the case that a single channel access failure counter is maintained at the UE side, the indicator may directly indicate the number of failed channel access procedures, i.e., the value of the counter, which may implicitly indicate whether the number of failed channel access procedures reaches the maximum value. In an embodiment, the indicator may be contained in periodic CSI reporting as an independent field. The reporting period of the indicator may be M times of the configured CSI reporting period, wherein M is a positive integer and can be configured by an RRC signaling. The presence of the field containing the indicator can be configured by an RRC signaling. In another embodiment, the indicator may be contained in aperiodic CSI reporting as an independent field. The aperiodic CSI reporting can be triggered by the BS when the BS does not receive dynamically scheduled PUSCH or PUCCH for a while. The presence of the field containing the indicator can be configured by an RRC signaling.

In the case that multiple channel access failure counters are maintained at the UE side for different types of uplink channels, different types of channel access procedures, or different uplink transmit beams, respectively, the UE may transmit a respective indicator associated with a respective number of failed channel access procedures counted by each counter in a manner similar to that described above with respect to the case of a single counter. For example, the indicator for a particular counter may be a bit for indicating whether the number of failed channel access procedures counted by the particular counter reaches a maximum value of the particular counter, or directly indicate the number of failed channel access procedures counted by the particular counter. For example, different indicators for different counters may be contained in periodic CSI reporting, aperiodic CSI reporting, or HARQ-ACK codebook as different fields.

According to some embodiments of the present disclosure, after transmitting the indicator explicitly or implicitly indicating that the number of failed channel access procedures counted by a counter reaches the maximum value of the counter, the UE may reset the counter.

As shown in FIG. 2, after receiving the indicator associated with the number of failed channel access procedures, the BS may schedule an uplink transmission for the UE at operation 206 based at least in part on the indicator. For example, when the indicator explicitly or implicitly indicates that the number of failed channel access procedures is larger than or equal to the maximum value, the BS may schedule the uplink transmission on a licensed carrier or another unlicensed carrier with a channel condition better than the unlicensed carrier on which the failed channel access procedures are performed, or the BS may schedule the uplink transmission on another uplink transmit beam on the same unlicensed carrier with a channel condition better than the uplink transmit beam for which the failed channel access procedures are performed. When the indicator explicitly or implicitly indicates that the number of failed channel access procedures is less than the maximum value, the BS may continue to schedule the uplink transmission for the UE on the same unlicensed carrier or the same uplink transmit beam.

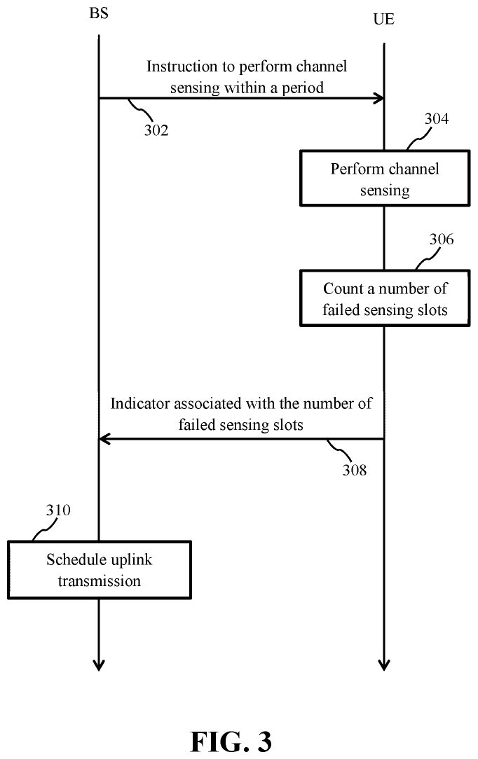

FIG. 3 illustrates an exemplary flow chart of another method for providing assistant information for uplink scheduling according to some embodiments of the present disclosure. The BS and the UE illustrated in FIG. 3 may be any BS (e.g., the BS 102 in FIG. 1) and any UE (e.g., the UE 104 in FIG. 1) described herein.

As shown in FIG. 3, at operation 302, the BS may transmit to the UE an instruction to perform channel sensing within a period (also called “channel sensing period” herein) on one or more carriers. In an embodiment, the instruction can be indicated by a bit in downlink control information (DCI), and the DCI also indicates a resource for aperiodic CSI reporting including the channel sensing result. The starting slot of the channel sensing period can be indicated by an offset to the slot where the instruction (e.g., the DCI) is received. The offset may be preconfigured, e.g., by an RRC signalling. Alternatively or additionally, the offset may be indicated by the instruction (e.g., indicated in the DCI). Similarly, the duration of the channel sensing period may be preconfigured, e.g., by an RRC signalling, or be indicated by the instruction (e.g., indicated in the DCI). The one or more carriers may be preconfigured, e.g., by an RRC signalling, or be indicated by the instruction (e.g., indicated in the DCI).

According to some embodiments of the present disclosure, the BS may mute all downlink and uplink transmissions within the channel sensing period. According to some other embodiments of the present disclosure, the BS may configure resource(s) for channel sensing by the UE, and perform downlink or uplink transmission(s) on other resource(s) within the channel sensing period. For example, the BS may configure a set of time-frequency resources and leave the set of time-frequency resources empty within the channel sensing period for the UE to perform channel sensing, while the remaining resource(s) within the channel sensing period may be used for downlink or uplink transmission(s).

As shown in FIG. 3, after receiving the instruction from the BS, the UE may perform channel sensing in sensing slots within the channel sensing period at operation 304. Each sensing slot has a duration, e.g., 9 μs. The UE may persistently sense the channel in unit of the sensing slot duration within the channel sensing period.

At operation 306, the UE may count a number of failed sensing slots within the channel sensing period. This can be implemented by maintaining at least one counter at the UE side. The at least one counter can be referred to as “channel sensing failure counter.”

When the UE has multiple uplink transmit beams, independent channel sensing may be performed for each uplink transmit beam. According to some embodiments of the present disclosure, the UE may maintain separate channel sensing failure counters for different uplink transmit beams respectively. For example, the UE may maintain a first counter to count a first number of failed sensing slots for a first uplink transmit beam, and maintain a second counter to count a second number of failed sensing slots for a second uplink transmit beam. The first counter is incremented by one upon each failed sensing slot for the first uplink transmit beam, and the second counter is incremented by one upon each failed sensing slot for the second uplink transmit beam. According to some other embodiments of the present disclosure, the UE may maintain a single counter to count failed sensing slots for different uplink transmit beams. The single counter is incremented by one upon each failed sensing slot regardless of the uplink transmit beam.

As shown in FIG. 3, at operation 308, the UE may transmit an indicator associated with the number of failed sensing slots counted at operation 306 to the BS. The indicator can be transmitted in CSI reporting on the resource indicated by the DCI carrying the instruction to perform channel sensing which is transmitted to the UE at operation 302.

According to some embodiments of the present disclosure, in the case that a single channel sensing failure counter is maintained at the UE side, the indicator is a bit for indicating whether the number of failed sensing slots (represented by the value of the counter) is larger than or equal to a maximum value or a threshold. For example, when the number of failed sensing slots is larger than or equal to the maximum value or the threshold, the bit is set to “1”; otherwise, the bit is set to “0”. In an embodiment, the maximum value or the threshold can be predefined in standards. In another embodiment, the maximum value or the threshold can be configured by the BS. For example, the BS may select the maximum value or the threshold from a set of possible values and indicate it to the UE via a signaling (e.g., RRC signaling).

According to some other embodiments of the present disclosure, in the case that a single channel sensing failure counter is maintained at the UE side, the indicator can be a bit for indicating whether a proportion of the number of failed sensing slots (represented by the value of the counter) to a total number of sensing slots within the channel sensing period is larger than or equal to a maximum value or a threshold. For example, when the proportion is larger than or equal to the maximum value or the threshold, the bit is set to “1”; otherwise, the bit is set to “0”. In an embodiment, the maximum value or the threshold is predefined in standards. In another embodiment, the maximum value or the threshold can be configured by the BS. For example, the BS may select the maximum value or the threshold from a set of possible values and indicate it to the UE via a signaling (e.g., RRC signaling).

In the case that multiple channel sensing failure counters are maintained at the UE side for different uplink transmit beams, respectively, the UE may transmit a respective indicator associated with a respective number of failed sensing slots counted by each counter in a manner similar to that described above with respect to the case of a single channel sensing failure counter. For example, the indicator for a particular counter may be a bit for indicating whether the number of failed sensing slots counted by the particular counter is larger than or equal to a maximum value or a threshold for the particular counter, or a bit for indicating whether a proportion of the number of failed sensing slots counted by the particular counter to a total number of sensing slots within the channel sensing period is larger than or equal to a maximum value or a threshold for the particular counter. For example, different indicators for different counters may be contained in the CSI reporting as different fields.

According to some embodiments of the present disclosure, after transmitting the indicator associated with the number of failed sensing slots counted by a counter, the UE may reset the counter.

As shown in FIG. 3, after receiving the indicator associated with the number of failed sensing slots, the BS may schedule an uplink transmission for the UE based at least in part on the indicator at operation 310. For example, when the indicator indicates that the number of failed sensing slots is larger than or equal to a predefined or configured maximum value or threshold, or that a proportion of the number of failed sensing slots to a total number of sensing slots within the channel sensing period is larger than or equal to a predefined or configured maximum value or threshold, the BS may schedule the uplink transmission on a licensed carrier or another unlicensed carrier with a channel condition better than the unlicensed carrier on which the failed channel sensing is performed, or the BS may schedule the uplink transmission on another uplink transmit beam on the same unlicensed carrier with a channel condition better than the uplink transmit beam for which the failed channel sensing is performed; otherwise, the BS may continue to schedule the uplink transmission for the UE on the same unlicensed carrier or the same uplink transmit beam.

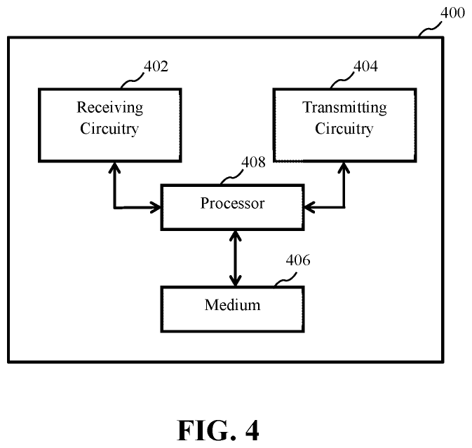

FIG. 4 illustrates an exemplary block diagram of an apparatus 400 according to some embodiments of the present disclosure. In some embodiments of the present disclosure, the apparatus 400 may be any UE (e.g., the UE 104 in FIG. 1 or the UE in FIG. 2 or FIG. 3) described herein or other devices having similar functionality, which can at least perform the operations illustrated in FIG. 2 or FIG. 3.

As shown in FIG. 4, the apparatus 400 may include at least one receiving circuitry 402, at least one transmitting circuitry 404, at least one non-transitory computer-readable medium 406, and at least one processor 408 coupled to the at least one receiving circuitry 402, the at least one transmitting circuitry 404, the at least one non-transitory computer-readable medium 406. While shown to be coupled to each other via the at least one processor 408 in the example of FIG. 4, the at least one receiving circuitry 402, the at least one transmitting circuitry 404, the at least one non-transitory computer-readable medium 406, and the at least one processor 408 may be coupled to one another in various arrangements. For example, the at least one receiving circuitry 402, the at least one transmitting circuitry 404, the at least one non-transitory computer-readable medium 406, and the at least one processor 408 may be coupled to each other via one or more local buses (not shown for simplicity).

Although in FIG. 4, elements such as receiving circuitry 402, transmitting circuitry 404, non-transitory computer-readable medium 406, and processor 408 are described in the singular, the plural is contemplated unless limitation to the singular is explicitly stated. In some embodiments of the present disclosure, the at least one receiving circuitry 402 and the at least one transmitting circuitry 404 can be combined into a single device, such as a transceiver. In certain embodiments of the present disclosure, the apparatus 400 may further include an input device, a memory, and/or other components.

In some embodiments of the present disclosure, the at least one non-transitory computer-readable medium 406 may have stored thereon computer-executable instructions which are programmed to cause the at least one processor 408 to implement the operations of the method, for example, as described in view of FIG. 2 or FIG. 3, with the at least one receiving circuitry 402 and the at least one transmitting circuitry 404.

For example, when executed, the instructions may cause the at least one processor 408 to count a number of failed channel access procedures. The instructions may further cause the at least one processor 408 to transmit, with the at least one transmitting circuitry 404, an indicator associated with the number of failed channel access procedures.

As another example, when executed, the instructions may cause the at least one processor 408 to receive, with the at least one receiving circuitry 402, an instruction to perform channel sensing within a period. The instructions may further cause the at least one processor 408 to perform channel sensing in sensing slots within the period, and count a number of failed sensing slots within the period. The instructions may further cause the at least one processor 408 to transmit, with the at least one transmitting circuitry 404, an indicator associated with the number of failed sensing slots.

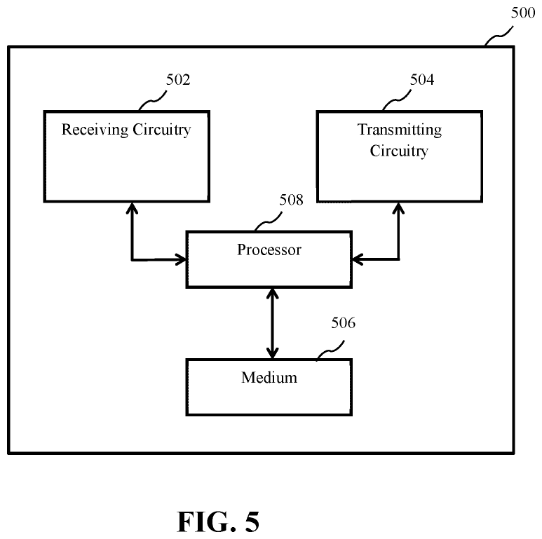

FIG. 5 illustrates an exemplary block diagram of an apparatus 500 according to some embodiments of the present disclosure. In some embodiments of the present disclosure, the apparatus 500 may be any BS (e.g., the BS 102 in FIG. 1 or the BS in FIG. 2 or FIG. 3) or other devices having similar functionality, which can at least perform the operations illustrated in FIG. 2 or FIG. 3.

As shown in FIG. 5, the apparatus 500 may include at least one receiving circuitry 502, at least one transmitting circuitry 504, at least one non-transitory computer-readable medium 506, and at least one processor 508 coupled to the at least one receiving circuitry 502, the at least one transmitting circuitry 504, the at least one non-transitory computer-readable medium 506. While shown to be coupled to each other via the at least one processor 508 in the example of FIG. 5, the at least one receiving circuitry 502, the at least one transmitting circuitry 504, the at least one non-transitory computer-readable medium 506, and the at least one processor 508 may be coupled to one another in various arrangements. For example, the at least one receiving circuitry 502, the at least one transmitting circuitry 504, the at least one non-transitory computer-readable medium 506, and the at least one processor 508 may be coupled to each other via one or more local buses (not shown for simplicity).

Although in FIG. 5, elements such as receiving circuitry 502, transmitting circuitry 504, non-transitory computer-readable medium 506, and processor 508 are described in the singular, the plural is contemplated unless limitation to the singular is explicitly stated. In some embodiments of the present disclosure, the at least one receiving circuitry 502 and the at least one transmitting circuitry 504 can be combined into a single device, such as a transceiver. In certain embodiments of the present disclosure, the apparatus 500 may further include a memory and/or other components.

In some embodiments of the present disclosure, the at least one non-transitory computer-readable medium 506 may have stored thereon computer-executable instructions which are programmed to cause the at least one processor 508 to implement the operations of the method, for example, as described in view of FIG. 2 or FIG. 3, with the at least one receiving circuitry 502 and the at least one transmitting circuitry 504.

For example, when executed, the instructions may cause the at least one processor 508 to receive, with the at least one receiving circuitry 502, an indicator associated with a number of failed channel access procedures from a UE. The instructions may further cause the at least one processor 508 to schedule an uplink transmission for the UE based at least in part on the indicator.

As another example, when executed, the instructions may cause the at least one processor 508 to transmit, with the at least one transmitting circuitry 504, an instruction to perform channel sensing in sensing slots within a period to a UE. The instructions may further cause the at least one processor 508 to receive, with the at least one receiving circuitry 502, an indicator associated with a number of failed sensing slots within the period from a UE. The instructions may further cause the at least one processor 508 to schedule an uplink transmission for the UE based at least in part on the indicator.

As will be appreciated by one skilled in the art, aspects of the embodiments may be embodied as a system, apparatus, method, or a program product. Accordingly, embodiments may take the form of an all-hardware embodiment, an all-software embodiment (including firmware, resident software, micro-code, etc.) or an embodiment combining software and hardware aspects.

For example, the disclosed embodiments may be implemented as a hardware circuit comprising custom very-large-scale integration (VLSI) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, or program code. The storage devices may be tangible, non-transitory, or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but is not limited to being, an electronic, magnetic, optical, electromagnetic, infrared, holographic, micromechanical, or semiconductor system, apparatus, or device, or any suitable combination of the foregoing.

A non-exhaustive list of more specific examples of the storage device may include the following: an electrical connection having one or more wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Furthermore, the described features, structures, or characteristics of the embodiments may be combined in any suitable manner. While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.”

1-60. (canceled)

61. An apparatus, comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry, and the at least one transmitting circuitry,
wherein the computer-executable instructions cause the at least one processor to implement a method for wireless communications, the method comprising:
counting a first number of failed channel access procedures; and
transmitting a first indicator associated with the first number of failed channel access procedures.

62. The apparatus of claim 61, wherein the first indicator is one bit for indicating whether the first number of failed channel access procedures reaches a maximum value.

63. The apparatus of claim 61, wherein the first indicator indicates the first number of failed channel access procedures.

64. The apparatus of claim 61, wherein the first indicator is transmitted in periodic channel state information reporting.

65. The apparatus of claim 61, wherein the first indicator is transmitted in channel state information reporting triggered by a base station.

66. The apparatus of claim 61, wherein the first number of failed channel access procedures is associated with different types of failed channel access procedures counted by a single counter.

67. The apparatus of claim 61, wherein the first number of failed channel access procedures is associated with failed channel access procedures for different types of uplink channels counted by a single counter.

68. The apparatus of claim 61, wherein the first number of failed channel access procedures is associated with failed channel access procedures for different uplink transmit beams counted by a single counter.

69. The apparatus of claim 61, wherein the first number of failed channel access procedures is associated with a first type of failed channel access procedures, and the method further comprises:
counting a second number of a second type of failed channel access procedures; and
transmitting a second indicator associated with the second number of the second type of failed channel access procedures.

70. The apparatus of claim 61, wherein the first number of failed channel access procedures is associated with failed channel access procedures for a first type of uplink channels, and the method further comprises:
counting a second number of failed channel access procedures for a second type of uplink channels; and
transmitting a second indicator associated with the second number of failed channel access procedures for the second type of uplink channels.

71. The apparatus of claim 61, wherein the first number of failed channel access procedures is counted by a counter, and the method further comprises resetting the counter in response to a successful channel access procedure.

72. The apparatus of claim 61, wherein the first number of failed channel access procedures is counted by a counter, and the method further comprises resetting the counter after transmitting the first indicator which indicates that the first number of failed channel access procedures reaches a maximum value.

73. An apparatus, comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry, and the at least one transmitting circuitry,
wherein the computer-executable instructions cause the at least one processor to implement method for wireless communications, comprising:
receiving, from a user equipment (UE), an indicator associated with a number of failed channel access procedures; and
scheduling an uplink transmission for the UE based at least in part on the indicator.

74. The apparatus of claim 73, wherein the indicator is one bit for indicating whether the number of failed channel access procedures reaches a maximum value.

75. The apparatus of claim 73, wherein the indicator indicates the number of failed channel access procedures.

76. The apparatus of claim 73, wherein the indicator is received in periodic channel state information reporting.

77. The apparatus of claim 73, further comprising triggering aperiodic channel state information reporting from the UE, wherein the indicator is received in the aperiodic channel state information reporting.

78. The apparatus of claim 74, wherein the indicator is received in a hybrid automatic repeat request (HARQ) acknowledgment (ACK) codebook.

79. An apparatus, comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry, and the at least one transmitting circuitry,
wherein the computer-executable instructions cause the at least one processor to implement a method for wireless communications, the method comprising:
receiving an instruction to perform channel sensing within a period;
performing channel sensing in sensing slots within the period;
counting a first number of failed sensing slots within the period; and
transmitting a first indicator associated with the first number of failed sensing slots.

80. The apparatus of claim 79, wherein the first indicator is:
one bit for indicating whether the first number of failed sensing slots is larger than or equal to a maximum value; or
one bit for indicating whether a proportion of the first number of failed sensing slots to a total number of the sensing slots within the period is larger than or equal to a maximum value.
